(19) United States
(12) Patent Application Publication
(10) Pub. No.: US 2011/0244928 A1
(43) Pub. Date: Oct. 6, 2011

(54) HANDS-FREE HELPER

(76) Inventors: Peter Louis CHERPES, Haymarket, VA (US); Guru Amrit Singh KHALSA, Herndon, VA (US)

(21) Appl. No.: 13/012,195

(22) Filed: Jan. 24, 2011

Related U.S. Application Data
(60) Provisional application No. 61/319,483, filed on Mar. 31, 2010.

(51) Int. Cl. H04M 1/00

(52) U.S. Cl. 455/569.1

(57) ABSTRACT

Remote assistance for users of hands-free communications devices is provided as a service. A user registers a hands-free communications device and the user. The service is requested in instances either automatically, upon notification that a trigger has been initiated, or upon request of the user. An agent is notified to contact the user and, upon obtaining authorization from the user of the hands-free communications device for which the service trigger has been automatically activated, the agent takes control remotely of at least one application on the hands-free communications device for which the service trigger has been initiated.

### CROSS-REFERENCE TO RELATED APPLICATIONS

This application claims the benefit of U.S. Provisional Patent Application No. 61/319,483, filed on Mar. 31, 2010, the disclosure of which is expressly incorporated herein by reference in its entirety.

### BACKGROUND

1. Field of the Disclosure

The present disclosure relates to assisting users of hands-free communications devices. More particularly, the present disclosure relates to providing a remote assistance service for users of hands-free communications devices.

2. Background Information

Hands-free use of devices is sometimes the only use authorized by law, such as in circumstances where laws prohibit drivers from holding a communications device (e.g., telephone, smart phone or personal digital assistant) while driving. Additionally, some users may not be able to physically use their hands and/or eyes to operate a device, but may be able to use a device in a hands-free mode.

Communications devices that operate partially or fully in a hands-free mode are referred to herein as hands-free communications devices. Such hands-free communications devices may require a user to use their hands initially, such as to place or receive a call by pressing buttons on a keypad. These hands-free communications devices operate at least some of the time in a hands-free mode to allow users to communicate with a remote party without using their hands after a connection is established.

Development of Bluetooth and similar protocols has allowed manufacturers to produce peripheral devices that interoperate with hands-free communications devices to allow the hands-free communications devices to operate in hands-free communications modes. Such peripheral devices include headsets with earpieces and/or mouthpieces, and vehicle microphones and vehicle speakers, any of which may be connected wirelessly and/or through a hardwired connection to the user's hands-free communications device so as to enhance the ability of the user to communicate with a remote party using the hands-free communications device.

### BRIEF DESCRIPTION OF THE DRAWINGS

FIG. 1 shows the components of an exemplary computing device used in a hands-free helper system as described herein, according to an aspect of the present disclosure;

FIG. 2 shows a network diagram of exemplary components of a hands-free helper system, according to an aspect of the present disclosure;

FIG. 3 shows applications provided by an exemplary application server in a hands-free helper system, according to an aspect of the present disclosure;

FIG. 4 shows an exemplary method of providing an automated hands-free application service, according to an aspect of the present disclosure; and

FIG. 5 shows another exemplary method of providing a user-initiated hands-free application service, according to an aspect of the present disclosure.

### DETAILED DESCRIPTION

In view of the foregoing, the present disclosure, through one or more of its various aspects, embodiments and/or specific features or sub-components, is thus intended to bring out one or more of the advantages as specifically noted below.

According to an aspect of the present application a method of providing remote assistance for users of hands-free devices includes registering, using a tangible centralized server, a hands-free device and a user of the hands-free device for a remote assistance service. Notification is received that a service trigger has been automatically activated for the hands-free device. An agent is notified to contact a user of the hands-free device for which the service trigger has been automatically activated. Remote control is taken of at least one application on the hands-free device for which the service trigger has been automatically activated, and the user of the hands-free device is remotely assisted.

According to an aspect of the present disclosure, a method of providing remote assistance for users of hands-free devices includes registering, using a tangible centralized server, a hands-free device and a user of the hands-free device for a remote assistance service. A request is received from a user of a hands-free device for a hands-free service. The user of the hands-free device is contacted using the tangible centralized server. An application on the hands-free device is accessed. The application on the hands-free device is controlled so as to remotely assist the user of the hands-free device.

According to an aspect of the present disclosure, a method of providing remote assistance for users of hands-free devices includes registering, at a tangible centralized server, hands-free devices and users of the hands-free devices for a remote assistance service. Agents are registered to provide the remote assistance service for the hands-free devices. Upon an occurrence of a triggering event, a registered user of a hands-free device is matched with a registered agent for a hands-free service. The registered agent is connected with the registered user. At least one application on the hands-free device is controlled so as to remotely assist the user of the hands-free device.

According to another aspect of the present disclosure, pre-authorization for remote control of the at least one application on the hands-free device is received before the notification.

According to yet another aspect of the present disclosure, authorization for controlling the application is received subsequent to receipt of the request for hands-free service.

According to still another aspect of the present disclosure, the remote assistance service is provided using real-time voice communications.

According to another aspect of the present disclosure, the remote assistance service is provided over a wireless network.

According to yet another aspect of the present disclosure, the user activates the hands-free service by interacting with a dedicated interface of the remote user device, and afterwards is provided with the hands-free service without touching the remote user device.

According to still aspect of the present disclosure, the registered user selects the registered agent, and the matching is based on the selection of the registered agent by the registered user.

According to yet another aspect of the present disclosure, registered agents are scheduled to be available for matching at dates and times chosen by the registered agents.

According to still another aspect of the present disclosure, registered agents are scheduled to be available for matching with users upon demand of a provider of the remote assistance based on aggregate demand of users.

According to another aspect of the present disclosure, the service trigger is automatically activated based on a location of the hands-free device.

According to yet another aspect of the present disclosure, the triggering event is based on a change in location of the hands-free device.

According to still another aspect of the present disclosure, the registered agent is a member of a group of at least one agents connected with the registered user.

According to another aspect of the present disclosure, the registered user is matched to the registered agent based on the identity of the at least one application on the hands-free device.

According to yet another aspect of the present disclosure, the method of providing remote assistance is provided using at least one of software purchased by a user of the hands-free device and a subscription subscribed to by the user of the hands-free device.

According to the present application, a user requests a remote agent to provide assistance with one or more applications on a hands-free communications device used by the user. A session between a user and a remote agent includes voice communications between the user and the remote agent, and remote control of the user's hands-free communications device by the agent. The voice communications and remote control occur simultaneously at times during a single session. The user's hands-free communications device has a hands-free mode in which physical input is not required by the user. In the hands-free mode, one or more applications on the hands-free communications device are remotely controlled by the remote agent during a period in which the user also uses the hands-free communications device to communicate verbally with the remote agent.

The user's hands-free communications device is used by the user to establish communications between the user and the agent. The user's hands-free communications device is also used by the user to communicate verbally with the agent while the agent remotely controls the user's hands-free communications device on behalf of the user. A session between the user and the remote agent therefore includes simultaneous voice communications and remote control of the user's hands-free communications device by the remote agent.

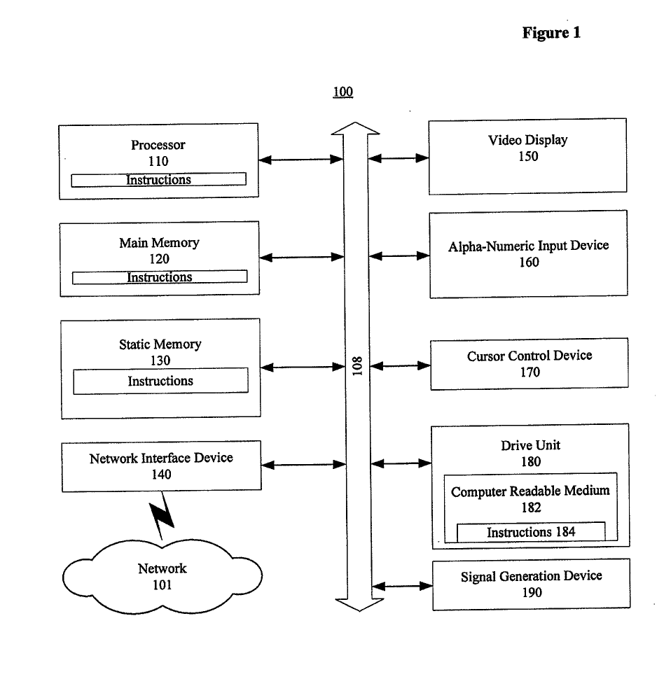

FIG. 1

FIG. 1 is an illustrative embodiment of a computing device according to the present application. The computing device in FIG. 1 is shown generically with representative components by which a hands-free helper service is provided. The computing device in FIG. 1 may be a tangible client computer, a server computer, a fixed computer, a mobile computer, a smart phone, a personal digital assistant (PDA), or any other type of communications device which includes memory, processing and communications functionality as described. The computing device in FIG. 1 illustrates tangible components of exemplary user communications devices, agent devices and network components such as servers as described herein.

The computing device 100 can also be implemented as or incorporated into various devices, such as a personal computer (PC), a tablet PC, a set-top box (STB), a personal digital assistant (PDA), a mobile device, a global positioning satellite (GPS) device, a palmtop computer, a laptop computer, a desktop computer, a wireless telephone, a web appliance, or any other machine capable of executing a set of instructions (sequential or otherwise) that specify actions to be taken by that machine. The computing device is designated 100 in FIG. 1. The computing device 100 can include a set of instructions that can be executed to cause the computing device 100 to perform any one or more of the methods or computer based functions disclosed herein. The computing device 100 may operate as a standalone device or may be connected, for example, using a network 101, to other computer systems or peripheral devices. In a particular embodiment, the computing device 100 can be implemented using electronic devices that provide voice, video or data communication. Further, while a single computing device 100 is illustrated, the term “system” shall also be taken to include any collection of systems or sub-systems that individually or jointly execute a set, or multiple sets, of instructions to perform one or more computer functions.

As illustrated in FIG. 1, the computing device 100 may include a processor 110, for example, a central processing unit (CPU), a graphics processing unit (GPU), or both. Moreover, the computing device 100 can include a main memory 120 and a static memory 130 that can communicate with each other via a bus 108. As shown, the computing device 100 may further include a video display 150, such as a liquid crystal display (LCD), an organic light emitting diode (OLED), a flat panel display, a solid state display, or a cathode ray tube (CRT). Additionally, the computing device 100 may include an input device 160, such as a keyboard or microphone, and a cursor control device 170, such as a mouse. The computing device 100 can also include a disk drive unit 180, a signal generation device 190, such as a speaker or remote control, and a network interface device 140.

In a particular embodiment, as depicted in FIG. 1, the disk drive unit 180 may include a computer-readable medium 182 in which one or more sets of instructions 184, e.g. software, can be embedded. A computer-readable medium 182 is a tangible article of manufacture, from which sets of instructions 184 can be read. Further, the instructions 184 may embody one or more of the methods or logic as described herein. In a particular embodiment, the instructions 184 may reside completely, or at least partially, within the main memory 120, the static memory 130, and/or within the processor 110 during execution by the computing device 100. The main memory 120 and the processor 110 also may include computer-readable media.

In an alternative embodiment, dedicated hardware implementations, such as application specific integrated circuits, programmable logic arrays and other hardware devices can be constructed to implement one or more of the methods described herein. Applications that may include the communications devices of various embodiments can broadly include a variety of electronic and communications devices. One or more embodiments described herein may implement functions using two or more specific interconnected hardware modules or devices with related control and data signals that can be communicated between and through the modules, or as portions of an application-specific integrated circuit.

In accordance with various embodiments of the present disclosure, the methods described herein may be implemented by software programs executable by a computer system. Further, in an exemplary, non-limited embodiment, implementations can include distributed processing, component/object distributed processing, and parallel processing. Alternatively, virtual computer system processing can be constructed to implement one or more of the methods or functionality as described herein.

The present disclosure contemplates a computer-readable medium 182 that includes instructions 184 or receives and executes instructions 184 responsive to a propagated signal, so that a device connected to a network 101 can communicate voice, video or data over the network 101. Further, the instructions 184 may be transmitted or received over the network 101 via the network interface device 140.

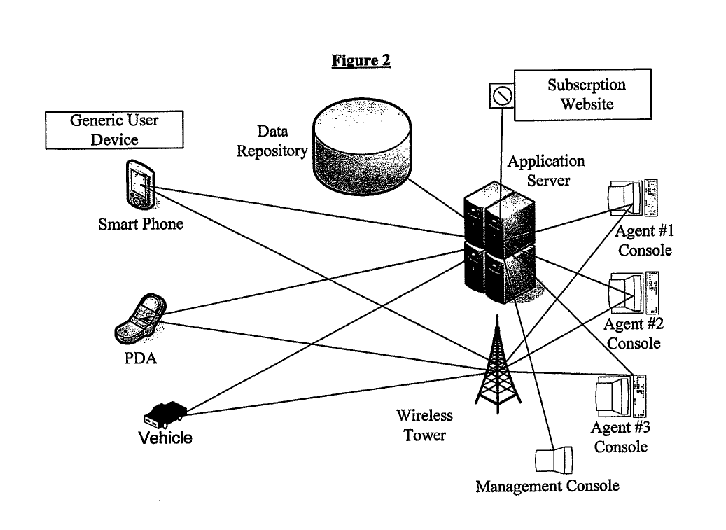

FIG. 2

FIG. 2 shows a network diagram of exemplary components of a hands-free helper system, according to an aspect of the present disclosure. As shown, the network includes user communications devices and a vehicle which includes peripheral devices as described herein. The network also includes agent consoles and a management console, an application server, a data repository and a wireless tower. The wireless tower is merely representative of any antenna used to propagate and/or receive wireless signals in a wireless network.

User Communications Devices

The network of FIG. 2 includes exemplary user hands-free communications devices, shown as a smart phone and a PDA, and an exemplary user peripheral device, shown as a vehicle with components (e.g., speakers and microphones) described herein as peripheral to a user hands-free communications device. So as to emphasize the broad nature of the user hands-free communications devices by which a hands-free helper service may be provided, one exemplary user hands-free communications device shown in FIG. 2 is labeled as a generic user device. Each user hands-free communications device shown in FIG. 2 is a computing device as shown in FIG. 1, and includes a processor, memory, and a network interface device for communicating over a network with a remote agent.

Each user hands-free communications device shown in FIG. 2 must either be assigned a unique identifier, or must be associated with a peripheral device assigned a unique identifier, such as a unique device identification or a unique communications address that can be used in conjunction with a temporary communications address. The unique identifier is necessary so that communications can be routed to the user hands-free communications device or peripheral device. Communications that are routed to the user hands-free communications devices shown in FIG. 2 include communications for applications provided on the user hands-free communications devices in FIG. 2, as well as communications with a remote agent and with other users across wired and wireless communications networks of any type.

Application Server

The network of FIG. 2 includes an application server which is in communication with the exemplary user hands-free communications devices. Although a single application server is shown in FIG. 2, this application server is merely representative of one or more server computers (e.g., application servers) which provide the functionality described herein with respect to the single application server in FIG. 2. The application server shown in FIG. 2 provides hands-free helper applications that are downloaded to the user hands-free communications devices so that users of the user hands-free communications devices can obtain the hands-free helper service either automatically upon detection of a trigger, or on-demand of the user.

The application server shown in FIG. 2 or another web server (not shown) provides a subscription and registration website by which a user may subscribe to or otherwise register with a hands-free helper service. A subscription may be based on a periodic charge such as a monthly or yearly fee, and/or may be based on a per-occurrence charge. The subscription website accepts user registration information including payment information such as a credit card authorization, as well as identification information for the user such as name, birthday and a password. The subscription website also obtains user hands-free communications device information so that the hands-free helper applications can be associated with and downloaded to the user hands-free communications devices.

Data Repository

A data repository is provided for the application server in FIG. 2. The data repository is representative of one or more tangible data repositories that may be used to store data and applications for user communications devices, users, agents, agent devices, website information, managers, payment mechanisms such as credit cards, and any other data used to provide the hands-free helper service. The data repository in FIG. 2 is accessed through the application server, and is therefore associated with data stored by the hands-free helper service described herein.

Agents/Agent Consoles

Agent consoles are connected to the application server and hands-free communication device over communications networks (not shown) in FIG. 2. The agent consoles may be provided in one or more call centers, or may be provided individually at agent homes or office locations. The agent consoles in FIG. 2 may be concentrated together or distributed apart.

Agents using the agent consoles represented in FIG. 2 are the helpers that provide the hands-free help described in the present application. In the event that the hands-free helper application is automatically triggered on a user hands-free communications device, the application server or another networked device is notified and an agent is determined. The agent may be determined based on data in the data repository, such as when a particular user has requested a particular agent or type of agent for assistance in advance. The agent may be determined based on a first available or best available algorithm, or any other method of selecting agents using, e.g., automatic call distributors, known in the art.

The agents use the agent consoles to communicate with users and to access and remotely control an application on the user hands-free communications device. As an example, the hands-free helper application running on the user hands-free communications device allows a remote agent to fully access data of one or more applications on a user hands-free communications device, and retrieve and/or input data on behalf of the user. That is, the remote agent remotely controls one or more applications on the user's hands-free communications device while the user uses the hands-free communications device to provide instructions verbally to the agent.

Communications Between Users and Agents

Communications between agents and users using hands-free communications devices necessarily include voice communications, such that communications between the agent consoles and the user communications devices may be provided by a standard communications protocol, such as voice over internet protocol (VoIP) via a terrestrial data network or mobile broadband data network, or voice over a public switched telephone network (PSTN) or voice over a cellular network (not shown). The voice communications between the user and the agent are provided so that the user may communicate with and instruct the agent as to what assistance is being requested. For user hands-free communications devices such as smart phones capable of simultaneous communications over separate voice and data networks, the user is connected with an agent over a voice or data network while the agent simultaneously controls one or more application on the user's hands-free communications device over a data network. A connection between user hands-free communications devices and agent consoles via a representative wireless tower is shown in FIG. 2. Voice and data communications may both be simultaneously provided over a broadband wireless network such as WiMAX (IEEE 802.16) or Long Term Evolution (LTE).

Automatic Triggers

Merely as an example, an automatic trigger may be activated when an incoming text message, email or other communication is received by the user hands-free communications device. A notification is automatically then sent to the application server, and ultimately an available agent is contacted and connected to the remote user hands-free communications device. The available agent then announces or the hands-free application indicates their presence, which may be over a speaker function, Bluetooth or other hands-free function of the remote user hands-free communications device or a peripheral device, and offers to review and read the incoming text message, email or provide other verbal communication of information to the user of the remote user hands-free communications device, without the need for the user to physically touch their hands-free communications device.

Remote Control

As set forth herein, a session is established between the user and the agent. The session includes both voice communications and remote control by the agent of one or more applications on the user's hands-free communications device. Remote control as used herein means that the agent is given partial or full shared visual and audible access to the user's communication device. By this access the agent, via the agent console, is able to view the screen of the remote device, hear audio that is played by the remote device, and is able to introduce control inputs such as cursor movements, touch screen actions or keyboard input remotely as if the agent was physically manipulating the device. The agent can then react to output as displayed on the device on behalf of the user, and/or communicate the output to the user.

In this way, the agent is allowed to access instant messaging, email, word processing or any other application running on the remote device. The agent can, for example, read documents, messages or emails, out loud to the user. The agent can also draft documents, messages or emails on behalf of the user. As an example, the remote agent may log in to the user's social networking account on a social networking website, and check messages for the user according to the user's instructions. The agent remotely controls the one or more applications on the user hands-free communications device using the hands-free helper application previously downloaded to the user hands-free communications device from the application server shown in FIG. 2.

An example of software that can be used to access and control a remote device is VNC provided by RealVNC of Cambridgeshire, United Kingdom. VNC is remote control software that allows a user to view and interact with a computer desktop over the internet using a program on another computer desktop anywhere on the Internet. This software can be used to control a mobile device from a personal computer, such that support can be provided for mobile devices by a remote agent using this type of software. The hands-free helper application will utilize a remote control functionality, whether as an embedded third-party component (widely available) or custom code within the hands-free application itself.

User Requests

As an alternative to automatic triggers, the user may activate a session by giving voice commands or by pressing a dedicated button or activating a similar mechanism on the user hands-free communications device or a peripheral. A dedicated button or similar mechanism may be provided either on the user hands-free communications device or, for example, on a peripheral device that cooperates with the user hands-free communications device. Either voice commands or pressing of a button or activation of a similar mechanism results in activation of the hands-free helper system. When the voice command is given or the dedicated button is pressed or similar mechanism is activated, a notification is automatically sent to the application server or other network component in FIG. 2, and ultimately an available agent is contacted and connected to the user's hands-free communications device. The available agent then announces or the hands-free application indicates their presence, which may be over a speaker function, Bluetooth or other hands-free function of the remote user hands-free communications device or a peripheral device.

As an example, a user of the hands-free communications device may be in a car and press a button on a peripheral device (e.g., the dashboard) to obtain from a remote agent assistance with a word processing, email or text application on the hands-free communications device. The voice communications and the word processing, email or text application may be provided via a user hands-free communications device such as a smart phone or laptop or PDA, and a peripheral device may be used to initially request the agent. In this way, a dedicated button may be pressed to activate the hands-free helper application on the hands-free communications device, and voice communications with the agent may be established over a cellular network via the hands-free communications device while data communications may be established separately over a data network via the hands-free communications device. The agent establishes access to and control of the word processing, email or text application on the user hands-free communications device using the hands-free helper application previously downloaded to the user hands-free communications device on which the word processing, email or text application is installed.

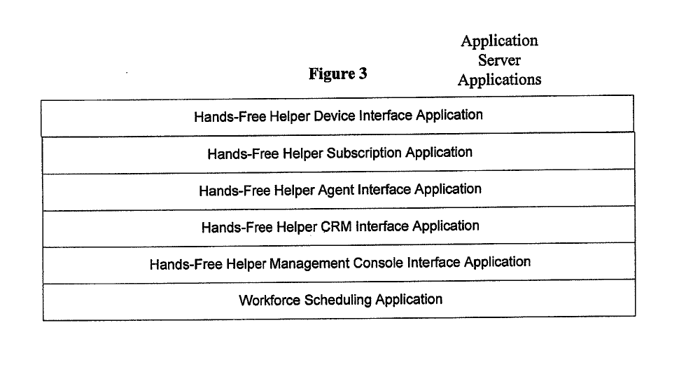

FIG. 3

FIG. 3 shows applications provided by an exemplary hands-free application server. In the embodiment of FIG. 3, an application server includes a hands-free helper device interface application, for interacting with the user hands-free communications device on which the hands-free helper application is provided. A hands-free helper subscription application is provided for obtaining registration/subscription information from users via a website. A hands-free helper agent interface application is provided for agents.

The hands-free helper agent interface application is used for agents to log-in when available. The hands-free helper agent interface application is also used for agents to obtain user information and user hands-free communications device information when requests for assistance from the user are routed to the agent. The hands-free helper agent interface application is used by the agent to interact with the remote user hands-free communications device in order for the agent to access and control the application on the user hands-free communications device for which assistance is sought.

A customer relations management interface application in FIG. 3 enables an administrator to view, modify and manage customer relations management software used in the hands-free helper application server. The customer relations management software may include the agent interface application and/or the device interface application, and generally is used to manage interactions such as algorithmic scripts for the agents to use when communicating with users.

A hands-free helper management console interface application is also provided in FIG. 3. The management console interface application allows the user to access system information such as agent performance, scheduling and availability, customer information, user wait time, agent monitoring (real-time and recorded), user complaints, user requests, and other information that helps managers ensure agent availability and user satisfaction.

A workforce scheduling application is used by managers and agents to ensure adequate staffing by agents for the hands-free helper service. The managers can dynamically request or mandate staffing by particular agents using such an application, and the agents can dynamically schedule their availability using such an application. Using such a workforce scheduling application, registered agents can be scheduled to be available dynamically based upon demand of a provider of a remote assistance based on aggregate demands of users. For example, if a provider notices a backlog of calls from users, the provider can send out a request for remote agents to log into the remote assistance service and become available for users. Of course, the agents can also schedule availability at dates and times of their own choosing when acceptable to the provider.

According to an aspect of the present disclosure, the workforce scheduling application is a self-managing workforce planner may be provided so that an agent workforce can be coordinated. Using the planner, agents can log-in through a website and see details related to demand for their services, including pay rates, projections for demand, the requested or required number of agents or opening left to be filled, and types of agent skills needed at certain times for specified pay rates. Managers can use the planner to set pay rates for specified hours so as to ensure agent staffing adequate to meet projected user demand. Managers can also post workforce openings and monitor demand in real-time, so that incentives for agents to join the workforce can be dynamically provided by a manager when so warranted by user demand. The workforce planner may also be programmed to provide automatic notifications to agents of the agent pool when demand exceeds projections such that services of additional agents are needed immediately or in the near future.

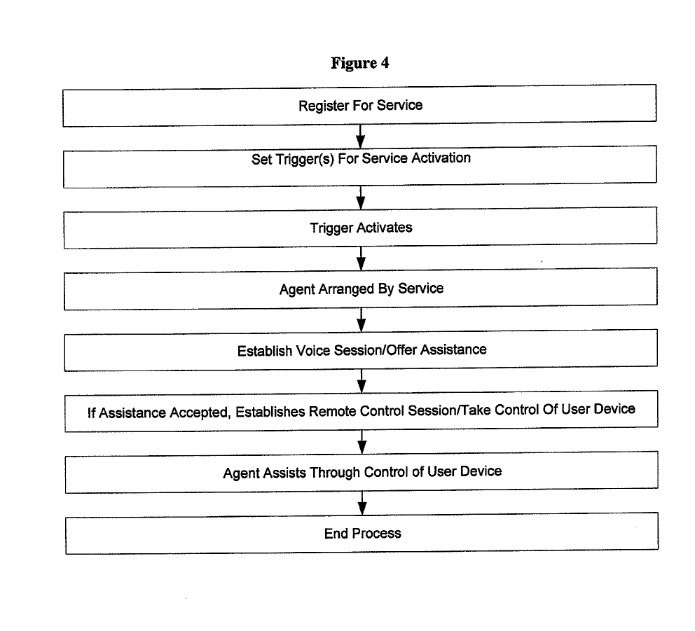

FIG. 4

FIG. 4 shows an exemplary method of providing an automated hands-free application service. In the embodiment of FIG. 4, a user registers a device for the hands-free helper service and sets triggers for the service to be automatically activated. As an example, the user may set triggers for incoming emails, texts, voicemails, or other incoming communications for accounts and applications used by the user on the user hands-free communications device. When the trigger activates, the service is contacted and an agent is arranged. A voice session is established after the agent is notified, and upon contacting the user the agent offers assistance to the user. The agent in this embodiment might communicate with the user by a speaker and microphone on the user hands-free communications device. The user is notified by an announcement from the agent or indication from the hands-free application that the agent is present and available to take control of the application for which the trigger has been activated. If the user accepts assistance, the agent initiates a session on the user's hands-free communications device and accesses the account on the user's hands-free communications device using the device interface application. The agent establishes a session of remote control of the user's hands-free communications device by taking control of one or more applications on the device so as to control the device and provide whatever service has been requested. In this example, a voice session is initiated before a remote control session, and authorization to control the application may be obtained only after the request for hands-free service is received. In another example, the trigger will initiate the voice and remote control session at the same time.

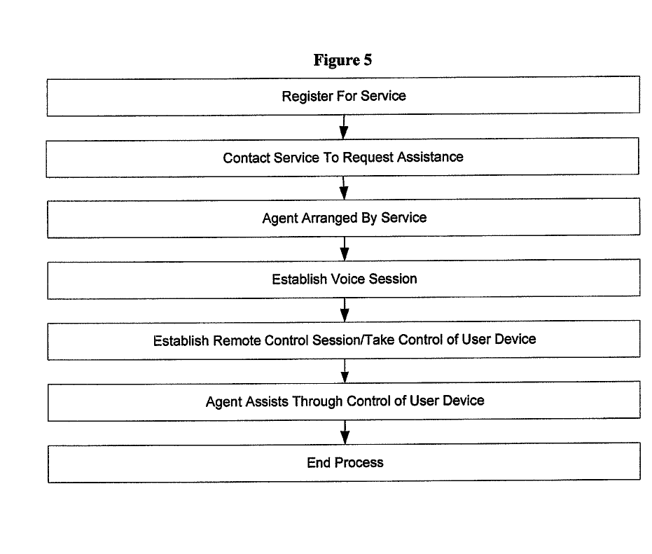

FIG. 5

FIG. 5 shows another exemplary method of providing a user-initiated hands-free application service. In the embodiment of FIG. 5, the user registers a hands-free communications device for a service. In the embodiment of FIG. 5, the user contacts the service to request assistance on a case-by-case basis. Thus, for example, the user hands-free communications device may be provided with a dedicated button or similar mechanism for a user to press or otherwise activate and thereby receive hands-free assistance from a remote agent. In this example, a user may press a button on a smart phone device, and the smart phone device contacts the service to request assistance. The service arranges an agent and a voice session is established between the agent and the user via the smart phone device.

In the example of FIG. 5, the service selects and contacts an agent, and the user is placed in contact with the selected agent. The user then requests assistance for whichever application on the user hands-free communications device the user wants help with, and the agent then accesses and establishes a session of remote control of the application on the user hands-free communications device to provide assistance to the user. In this example, a voice session is established before a remote control session. In another example, the trigger will initiate the voice and remote control session at the same time. In the latter example, remote control of at least one application on the hands-free device may be pre-authorized by the user before the request for remote assistance.

In this example, the agent may be asked to review and read an incoming text message, email or other communication to the user of the remote user hands-free communications device. In this way, the agent is allowed to access the text, email or other account or application of the user's hands-free communication device. Similarly, the agent may be asked to access a global positioning system application on the user hands-free communications device, and use the global positioning system application to provide the user with a location or directions.

In another example though, registered users may select a registered agent, and the matching is based on the selection of the registered agent by the registered user. Thus, a registered user may ask for a registered agent by name or identification, and the matching system may attempt to match the registered user in accordance with the user's request.

As described above, remote agent services can be provided on-demand for a user's hands-free communications device. Such a device may be, for example, a cell phone, PDA, smart phone, mobile device, personal digital assistant or mobile computer. Services may be provided to a hands-free communications device wirelessly, such as when the hands-free communications device is a wireless communications device configured to operate in a hands-free mode. The user's hands-free communications device may also utilize a peripheral such as vehicle speakers and a microphone via a vehicle docking station, so that the user's hands-free communications device communicates through a fixed docking station and possibly other equipment such as an antenna of the vehicle. The user's hands-free communications device may also communicate through other equipment in a vehicle using a local networking technology, such as WiFi connection or Bluetooth.

Similarly, a user's hands-free communications device may include an embedded trigger, such as a button, that the user can activate to request the remote agent services. An embedded trigger can also be provided otherwise in or on peripheral devices with which the user's hands-free communications device cooperates.

The user must be provided with a communications account so that an agent can communicate with the controlled user hands-free communications device. Such a communications account must be associated with a communications address, such as an IP address, device ID, telephone number, instant messaging or email address, video conferencing address, text message address etc.

The user's hands-free communications device may be provided with a global positioning satellite (GPS) application, a word processing application, or any other general productivity application that a user could use on the device. Using the service described herein, a remote agent can be requested to assist the user using one or more such application on the user's hands-free communications device, so that one or more applications on the user's hands-free communications device are operated and controlled remotely by the remote agent in accordance with the user's request to the agent. In this way, the remote agent can access and control a GPS application on the user's hands-free communications device to provide the user with the user's location or directions to a requested location. Similarly, the remote agent could access and control a word processing application on the user's hands-free communications device to draft a document for the user while the user is otherwise occupied.

The applications on the user's hands-free communications device for which the remote agent can provide assistance may include drawing programs, spreadsheet programs, messaging programs, email programs, word processing programs, internet access to specified websites, GPS applications, or any other programs which a user might wish to access. The agent may follow voice instructions from the user, such as instructions to enter a user name and password to a website to access the user's account on the website. The agent may also draft a particular type of document or message for the user in accordance with the user's instructions.

The user's hands-free communications device may have standard components of computing and communications devices, including keyboard, monitor, a screen, an antenna, a central processing unit (CPU) and memory. However, examples of a device that may be associated with a communications account and include communications capabilities include a vehicle, a toy, a mobile communications device, any device with an embedded communications application, or a word processing device.

The user's hands-free communications device could be fixed at a single location. For example, in the case of personal disabilities, a remote agent can assist a disabled user to use one or more applications on a computer. In this way, a remote agent might assist a user with limited use of hands and/or eyes or with any incapacity to operate the device to use applications on the user's computer. The user hands-free communications device can include a voice over internet protocol (VoIP) application, so that the user of the user hands-free communications device requests and communicates with the agent over the internet and the agent accesses and remotely controls the application embedded on the user hands-free communications device.

The hands-free helper service itself may be sold via a shrink-wrap package, where the user application is provided for the user to install on a user hands-free communications device, servers, and other computers. The service may also be sold as so-called “software as a service” (SAAS), where the use of the software is paid for on a periodic subscription or a per-use subscription basis. Finally, the service may be sold as a license, so that third-party service providers can themselves contract with users to arrange for users to obtain services from remote agents. Thus, different service providers may provide different agents and different agent services to a single user using the hands-free helper systems described herein. A user could then obtain assistance with one type of application from an agent at one service, and then obtain assistance with another type of application from a different agent at a different service. A coordinator or operator may be assigned to initially answer user requests and direct users to the appropriate agent or service.

Monitoring

The hands-free helper application on a user's hands-free communications device monitors the user's hands-free communications device to determine when a remote agent is to be requested. The monitor may determine that the user is directly requesting an agent, such as when a dedicated button or similar feature is provided on a user's hands-free communications device or on a peripheral device for the user to request a remote agent.

Triggers may also be set and monitored so that the hands-free helper application automatically determines when a remote agent is to be requested. Triggers may include receipt of incoming emails or texts, directional or location-based triggers monitored using GPS, numeric indicators for applications such as stock price, volume or technical triggers, timing triggers, or combinations of various of these or other like triggers. Triggers may be set for applications running on the user's hands-free communications device, and once the trigger is activated a notification is made to request a remote agent, resulting in the remote agent establishing a voice-based session and a remote control session with the user.

The monitor may also provide an alert to the user when the monitor is turned off or otherwise disabled. For example, the monitor may be set to monitor the location of the user hands-free communications device using a GPS application, and the monitor may notify the user when out of range of GPS satellites such that location cannot be properly monitored. Similarly, the monitor may be set to monitor phone settings or other communications applications, and the monitor may notify the user when phone or other communication coverage is lost.

Incoming Communications

Examples of what might be monitored for triggers include emails, texts, chat messages, video, alerts on a program running on a device, pop-up features, or other activities or content processed by the monitored user hands-free communications device. In an example, the monitor may also monitor applications such as social media messaging applications, a traffic application, or a weather application. As an example, an agent may be automatically requested based on a traffic and location (e.g., GPS) application to automatically contact the user when significant delays are expected on a route used by the user. Thus, content from third-party broadcasting sources such as radio stations or satellite services may be monitored by the application so as to result in a remote agent being notified when a trigger is activated.

The monitor may also monitor health events or personal events or automatic events using an application on the user's hands-free communications device. As an example, the user's hands-free communications device may be a health monitor worn on clothes or as a watch, or a heart rate monitor. The user's hands-free communications device may be a panic button with communications capabilities, so that an agent is requested when the button is pressed.

The user's hands-free communications device may also include environmental sensors which are monitored. For example, environmental sensors may be electronic gyroscopes that monitor spinning or falling by the user, or temperature sensors that measure external temperature, pressure sensors that monitor pressure in a cabin, humidity sensors, position sensors, directional sensors, chemical sensors, a compass, location sensors, sound sensors, picture or image sensors, or any other type of information sensors that can sense and analyze environmental data. The monitoring might be a security system monitor, a communications network monitor, or any of the other types of monitors noted herein.

Remote Human Agent

A remote agent is a remote human agent, and not a machine in this application. The remote human agent may be contacted according to a subscription or a per-use service. The service may be provided with an embedded communications capability. The remote human agent may be an employee of a call center, or a worker in a distributed workforce working from their homes. A 3^{rd} party may provide a service, separate from the hands-free helper application itself, to provide individual agents or types of agents for different uses and services.

Agents are authorized to provide services. Agents log-in to a hands-free helper application for agents. The agents are centrally tracked along with user requests, volume and characteristic data, so as to coordinate workforce scheduling and manpower allocation. A management module matches users and agents together, based on user models for each user, agent models for each agent, the nature of a particular request, a geographic location of the user when a request is made, or any other data that could be used to help match a user to the best remote agent available. Methods of user and agent matching include first available agent, best available agent, round robin, and longest wait. Agents may also be matched with users based on their expertise and/or familiarity with an application to be controlled on the user's device. In the latter example, agents may be selected based on the application to be controlled, the type of user device on which the application is installed, or the application or function that triggers the service.

When an agent is notified of a pending request for assistance, a screen pops up or is otherwise populated on a computer of the agent console used by the agent. The remote agents according to the present application are provided with the ability to remotely control one or more applications on a user hands-free communications device based on the hands-free helper application downloaded by the user to the user hands-free communications device.

The agent may be a “personal” agent for a particular user, such as when a user wishes to always obtain the services of a particular agent when that agent is available. An agent might be matched based on the requested services, skills possessed by the agent, or any other criteria which can be used to match users and agents. The agents communicate with the users through voice communications, and the agents have at least the ability to remotely control an application on the user's hands-free communications device if authorized.

The agent takes remote control of the user's hands-free communications device when authorized. Thus, the agent does not only share or view a workspace on the user's hands-free communications device, but also literally controls one or more applications on the user's hands-free communications device. As an example, the remote agent may draft a letter for the user on the user's hands-free communications device using a word processing program.

The remote control of the one or more applications on the user's hands-free communications device is performed separately, but in conjunction with, the voice communications between the user and the agent. Both the voice communications and the device control may be performed using a common network such as a mobile broadband network, or the voice communications may be provided using a wireless cellular voice network or PSTN while the device control is performed using a data network.

The device control may include control of any application or all applications or more than one application and less than all applications on the user hands-free communications device. The device access may also include access to any application or all applications or more than one application and less than all applications on the user hands-free communications device.

Agents may be employees of a hands-free helper service provider. Agents may also be employee's of other companies, such as the user's own company. Agents may also be individuals configured as agents by the user. For example, a user may install a hands-free helper application on a remote device in order to obtain assistance from family members designated as agents. In the latter example, the hands-free helper application may be programmed to use a contact number for the family member(s) in order to contact the family members either automatically or upon request of a user.

More than one agent may also be simultaneously or sequentially provided as part of a service. Similarly, multiple users may be simultaneously connected with a single agent as part of a service. For example, a group of users may be joined to a conference call by a single agent upon request using the remote assistance service. Multiple users travelling independently to a concert may also use the service to participate in a broadcast pool through a connection to an agent, even in instances where the multiple users do not know each other.

Agent/User Interaction

The interaction between users include voice communications and the agent remotely accessing and controlling one or more applications on the user's hands-free communications device when authorized. The voice communication is two way. The agent offers to provide information or a service.

The agent control of the user's hands-free communications device may be automatically authorized, such as when the user presses a dedicated button to obtain agent services. The agent control of the user's hands-free communications device may also be selectively authorized, such as when the user sets triggers to automatically request agent services including instances where the user declines the services once contacted by the agent.

Services

Services provided by an agent may include, but are not limited to: auditory information services, word processing, spreadsheeting, typing, writing, reading, 3 way calling, call control, call initiation, geographic/GPS assistance, call forwarding, voicemail access and review, text, email or other messaging access and review, traffic or weather, research, interne searching, and chat/companionship/dialogue/conversation.

The services may be provided using a software application purchased or provided free at a store or downloaded over the internet by a user. The software, once installed by the user, provides access to agents as described herein. Of course, the user may be required to subscribe to the remote assistant service before being allowed to access agents using such a free or purchased software application.

An example of a hands-free helper service is a service activated by a location-sensing application installed on a hands-free device. For example, in the example above of a family member designated as agent, a location-sensing application installed on a hands-free device might automatically notify a parent as agent that their child's hands-free device in an automobile has been driven beyond a specified geographic boundary.

Variability of Aspects of the Present Disclosure

As described above, a hands-free helper service allows users to request and obtain assistance from remote agents using a hands-free communications device. The users may use the service as a convenience or as a necessity. The service may be a periodic subscription service and/or a per-use service. Agents may be provided in a call center or distributed at their homes. The application server in FIG. 2 is merely representative of one or more tangible server communications used to provide the various applications used by users, agents and managers in the present application. Accordingly, the details described herein are merely exemplary and representative, and not absolute requirements except where noted.

A mobile device as described herein may include a circuit board which controls the logic for the device, an antenna by which information is transmitted to and from the device over the network, a liquid crystal display (LCD) for displaying visual content to a user, a charge coupled device or similar device for capturing an image when instructed to do so by a user, a keyboard by which a user can enter and select information, a microphone for capturing audible content from a user, a speaker for presenting audible content to a user, and a battery for storing power used to power the device. The circuit board may include a digital signal processor and microprocessor as known in the field of mobile communications devices. A smart phone as described herein is a mobile communications device configured with a processor and memory to communicate over separate voice and data networks.

A service as described herein may be provided by a program on a computer readable medium sold or given away at a store, or downloaded from the interne. The term “computer-readable medium” herein includes a single medium or multiple media, and may be an independent tangible object such as a portable memory, or a tangible component of a tangible device or apparatus. A computer-readable medium may be one or more databases that store one or more sets of instructions. The term “computer-readable medium” also includes any medium that is capable of storing, encoding or carrying a set of instructions for execution by a processor or that cause a computer system to perform any one or more of the methods or operations disclosed herein.

In an exemplary embodiment, the computer-readable medium can include a solid-state memory such as a memory card or other package that houses one or more non-volatile read-only memories. Further, the computer-readable medium can be a random access memory or other volatile re-writable memory. Additionally, the computer-readable medium can include a magneto-optical or optical medium, such as a disk or tapes or other storage device. Accordingly, the disclosure is considered to include any computer-readable medium or other equivalents and successor media, in which data or instructions may be stored.

The illustrations of the embodiments described herein are intended to provide a general understanding of the structure of the various embodiments. The illustrations are not intended to serve as a complete description of all of the elements and features of apparatus and systems that utilize the structures or methods described herein. Other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

Although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, will be apparent to those of skill in the art upon reviewing the description.

In the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

The above disclosed subject matter is to be considered illustrative, and not restrictive, and the appended claims are intended to cover all such modifications, enhancements, and other embodiments which fall within the true spirit and scope of the present disclosure. Thus, to the maximum extent allowed by law, the scope of the present disclosure is to be determined by the broadest permissible interpretation of the following claims and their equivalents, and shall not be restricted or limited by the foregoing detailed description.

What is claimed is:

1. A method of providing remote assistance for users of hands-free devices, comprising:
registering, using a tangible centralized server, a hands-free device and a user of the hands-free device for a remote assistance service;
receiving notification that a service trigger has been automatically activated for the hands-free device;
notifying an agent to contact a user of the hands-free device for which the service trigger has been automatically activated;
taking control remotely of at least one application on the hands-free device for which the service trigger has been automatically activated and remotely assisting the user of the hands-free device.

2. A method of providing remote assistance for users of hands-free devices, comprising:
registering, using a tangible centralized server, a hands-free device and a user of the hands-free device for a remote assistance service;
receiving a request from a user of a hands-free device for a hands-free service;
contacting, using the tangible centralized server, the user of the hands-free device;
accessing an application on the hands-free device;
controlling the application on the hands-free device so as to remotely assist the user of the hands-free device.

3. A method of providing remote assistance for users of hands-free devices, comprising:
registering, at a tangible centralized server, hands-free devices and users of the hands-free devices for a remote assistance service;
registering agents to provide the remote assistance service for the hands-free devices;
upon an occurrence of a triggering event, matching a registered user of a hands-free device with a registered agent for a hands-free service;
connecting the registered agent with the registered user;
controlling at least one application on the hands-free device so as to remotely assist the user of the hands-free device.

4. The method of claim 1, further comprising:
receiving pre-authorization for remote control of the at least one application on the hands-free device before the notification.

5. The method of claim 2, further comprising:
obtaining authorization for controlling the application subsequent to receipt of the request for hands-free service.

6. The method of claim 1,
wherein the remote assistance service is provided using real-time voice communications.

7. The method of claim 2,
wherein the remote assistance service is provided using real-time voice communications.

8. The method of claim 3,
wherein the remote assistance service is provided using real-time voice communications.

9. The method of claim 6,
wherein the remote assistance service is provided over a wireless network

10. The method of claim 7,
wherein the remote assistance service is provided over a wireless network

11. The method of claim 8,
wherein the remote assistance service is provided over a wireless network

12. The method of claim 2,
wherein the user activates the hands-free service by interacting with a dedicated interface of the remote user device, and afterwards is provided with the hands-free service without touching the remote user device.

13. The method of claim 3,
wherein the registered user selects the registered agent, and the matching is based on the selection of the registered agent by the registered user.

14. The method of claim 3,
wherein registered agents are scheduled to be available for matching at dates and times chosen by the registered agents.

15. The method of claim 3,
wherein registered agents are scheduled to be available for matching with users upon demand of a provider of the remote assistance based on aggregate demand of users.

16. The method of claim 1,
wherein the service trigger is automatically activated based on a location of the hands-free device.

17. The method of claim 3,
wherein the triggering event is based on a change in location of the hands-free device.

18. The method of claim 3,
wherein the registered agent is a member of a group of at least one agents connected with the registered user.

19. The method of claim 3,
wherein the registered user is matched to the registered agent based on the identity of the at least one application on the hands-free device.

20. The method of claim 1,
wherein the method of providing remote assistance is provided using at least one of software purchased by a user of the hands-free device and a subscription subscribed to by the user of the hands-free device.
